(19) United States
(12) Patent Application Publication
(10) Pub. No.: US 2004/0089468 A1
(43) Pub. Date: May 13, 2004

(54) Induction winding

(76) Inventors: Peter Carstensen, Huddinge (SE); Torbjorn Wass, Vasteras (SE); Bo Hernnas, Vasteras (SE)

Correspondence Address: SWIDLER BERLIN SHEREFF FRIEDMAN, LLP, 3000 K STREET, NW, BOX IP, WASHINGTON, DC, 20007, US

(21) Appl. No.: 10/470,976

(22) PCT Filed: Feb. 1, 2002
(86) PCT No.: PCT/SE02/00186

(30) Foreign Application Priority Data
Feb. 2, 2001 (SE) 0100308-6

(51) Int. Cl. H01B 5/08

(52) U.S. Cl. 174/128.1

(57) ABSTRACT

An induction winding (20) consisting of at least one turn, containing current-carrying means (10) comprising stranded conductors (11) arranged in at least one layer (12, 13, 14) where the said at least one layer is electrically insulated from adjacent layers (16, 17, 18) and at least two adjacent strands constituting the said at least one layer are uninsulated.

### TECHNICAL FIELD

The present invention relates to an induction winding consisting of at least one turn and an electric machine comprising said induction winding. More particularly, the present invention concerns an induction winding containing current-carrying means comprising stranded conductors arranged in at least one layer intended for use in static electric machines such as transformers, reactors, electromagnets, compensators, frequency converters and resonators as well as rotating machines such as motors and generators, primarily in high-voltage applications i.e. voltages in excess of 10 kV.

### BACKGROUND OF THE INVENTION

During the last few decades there has been an increasing demand for high voltage rotating electric machines. Since the voltage of a power network normally lies at a higher level than the voltage of the rotating electric machine, the use of a step-up transformer is necessary to connect the rotating electric machine to the power network. The transformer constitutes an extra cost and reduces the total efficiency of the system. It is therefore desirable to manufacture rotating electric machines for high voltages which can be connected directly to a power network without an intermediate transformer. This requires a suitable high-voltage induction winding.

The conducting material of induction windings is subjected to a magnetic field that induces eddy currents, resulting in losses. Eddy current losses can be decreased by breaking up the conducting path available to them. Induction windings incorporating means to minimize the magnitude of eddy current losses are preferred since they lead to significant energy savings. WO 97/45930 describes a conductor for high-voltage windings comprising two or more concentric layers of stranded conductors. Each layer is electrically insulated from adjacent layers to reduce eddy current losses between layers. Alternate strands in each layer are provided with an electrically insulating layer, such as enamel or extruded high-temperature plastic, so that no two uninsulated strands come into electrical contact with each other which limits eddy-current losses within individual layers. Providing certain wires with electrical insulation is an expensive and time-consuming process. Furthermore if a conductor comprising insulated and uninsulated strands is compressed in order to reduce the conductor dimension, the insulation becomes very difficult to remove leading to problems when connecting or joining such induction windings. It is stated that aluminium strands, the surface of which is oxidized, can be used to provide the requisite insulation within the layers, however this makes the winding more difficult to recycle compared to a winding comprising only copper or only aluminium strands.

### SUMMARY OF THE INVENTION

It is an object of this invention to provide a cheaper and more environmentally-friendly induction winding which is designed to sufficiently reduce eddy current losses and an electric machine comprising said winding.

This and other objects of the invention are achieved by arranging stranded conductors in one layer or a plurality of perimetrically superimposed layers where each layer is electrically insulated from any adjacent layers but where at least two adjacent strands constituting the said at least one layer are uninsulated. In another embodiment of the invention a majority of the strands constituting the said at least one layer are uninsulated. In a preferred embodiment of the invention all of the strands constituting the at least one layer are uninsulated.

Experiments have shown that eddy currents circulating between the layers are the dominant source of eddy current losses in the current-carrying means whereas eddy currents within the individual layers are negligible. The eddy currents within a single layer are small because of the contact resistance between the strands and because of the relatively small number of contact points giving rise to an induction area. It is therefore deemed unnecessary to provide alternate strands within a single layer with electric insulation. Using mainly/only uninsulated strands leads to a less expensive and more environmentally friendly induction winding as less or no insulation material is needed.

The current-carrying means of the present invention comprise at least one layer made up of strands of copper, aluminium or any other suitable metal. The stranded conductors are made out of pre-shaped strands or circular strands which are compressed after stranding to minimize the cross-section of the current-carrying means that they constitute. In another embodiment, the current-carrying means comprise stranded conductors having different cross-sections in the various layers. In order to minimize eddy current losses the maximum transverse dimension of the strands is 4 mm or preferably 2 mm. In a preferred embodiment the plurality of layers are substantially concentric.

The electric insulation between each layer of stranded conductors comprises paper for example carbonised conducting paper or a synthetic material such as a thermoplastic, or mica or a cross-linked material. In a preferred embodiment the electric insulation is applied longitudinally or wound onto the layers of stranded conductors.

The present invention relates to an electric machine comprising at least one induction winding consisting of at least one turn. The induction winding comprises current-carrying means, as described above, enclosed within a first semiconducting layer which is provided with a surrounding solid insulation layer and a second semiconducting layer which encases the solid insulation layer. In a preferred embodiment of the invention the first semiconducting layer is maintained at a potential substantially equal to the potential of the current-carrying means. The second semiconducting layer is connected to a predetermined potential such as ground potential. The semiconducting layers form equipotential surfaces and the electric field is uniformly distributed within the solid insulation layer. This eliminates the risk of breakdown of the insulating material due to local concentrations of the electric field. In another preferred embodiment of the invention the second semiconducting layer is grounded so that no electric field will exist outside its bounds.

The semiconducting layers preferably comprise a similar material as the solid insulation layer but contain conducting material for example carbon black. The semiconducting layers are arranged in intimate contact with the solid insulation layer. In one preferred embodiment the semiconducting layers and the solid insulation layer are joined by extruding them together to form a single unit which ensures no play occurs between the layers. It is important that no air is allowed to enter between the layers as this would lead to partial discharges in the insulation material at high electric field strengths.

### BRIEF DESCRIPTION OF THE DRAWING

A greater understanding of the present invention may be obtained from the subsequent description and the appended claims, taken in conjunction with the accompanying drawing, in which

FIG. 1 depicts the current-carrying means of an induction winding according to a preferred embodiment of the invention,

FIG. 2 shows a cross-sectional view of an induction winding according to a preferred embodiment of the invention,

FIG. 3 illustrates a 3-phase power transformer with a laminated core comprising an induction winding according to the present invention,

FIG. 4 depicts schematically an axial end-view of a sector of the stator in an electric machine according to the present invention,

FIG. 5 shows a graph of eddy current losses at different magnetic fields for various configurations of the current-carrying means having a cross-sectional area of 185 mm², and

FIG. 6 shows a graph of eddy current losses at different magnetic fields for various configurations of current-carrying means having a cross-sectional area of 70 mm².

### DESCRIPTION OF THE PREFERRED EMBODIMENTS

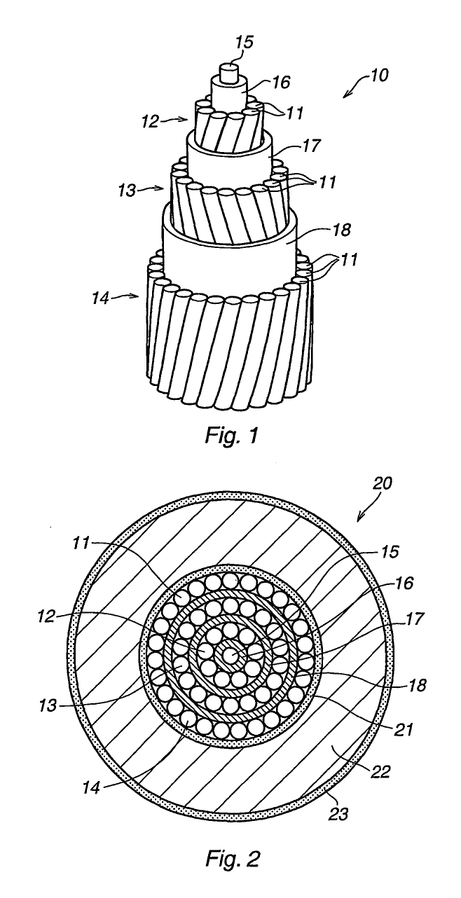

FIG. 1 shows current-carrying means 10 comprising circular strands 11, of 2 mm diameter copper wire for example, arranged in perimetrically superimposed layers 12, 13, 14 around a central conductor 15. The layers are arranged with an alternating stranding direction. Electric insulation 16, 17, 18 insulates adjacent layers. The strands 11 are uninsulated. The central conductor and the adjacent electrical insulation 16 can be replaced with air or another material.

The current-carrying means may of course be made up of more or fewer layers of strands depending on the demands placed on the current-carrying means. In another embodiment of the invention the layers may comprise strands of differing cross-sections. In a further embodiment of the invention, the induction winding comprises a single layer of strands. This single layer is for example located around the periphery of insulation material at the centre of the winding.

FIG. 2 shows a cross-sectional view of an induction winding 20 according to a preferred embodiment of the invention. The induction winding contains current-carrying means comprising circular strands 11 with uniform cross-section arranged in concentric layers 12, 13, 14 around a central stranded conductor 15. Layers of electric insulation 16, 17, 18 insulate adjacent layers. A first semiconducting layer 21 encloses the current-carrying means and a solid insulation layer 22 is provided around the first semiconducting layer. A second semiconducting layer 23 encases the solid insulation layer 22.

The solid insulation layer 22 comprises for example a thermoplastic such as low/high-density polyethylene, polypropylene, polybutylene, Teflon™, polyvinylchloride or mica, cross-linked material such as cross-linked polyethylene or rubber for example ethylene-propylene rubber or silicone rubber.

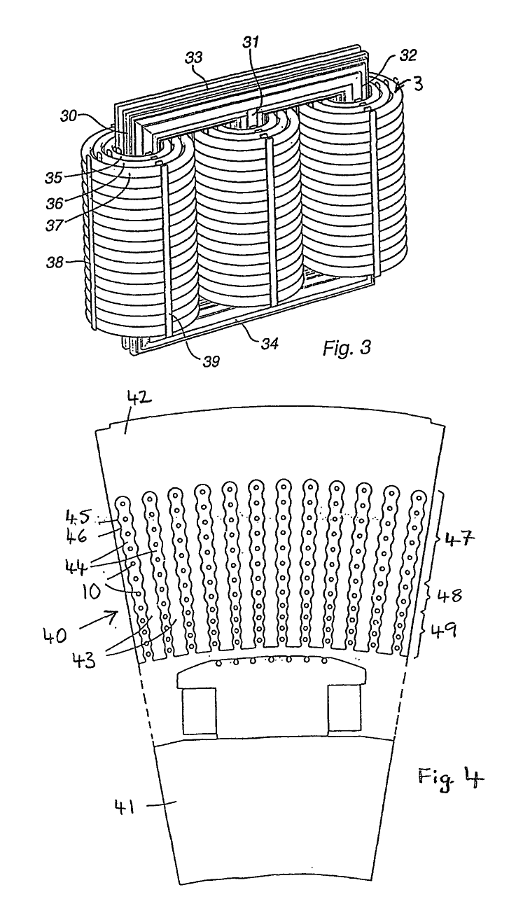

FIG. 3 illustrates a three-phase power transformer comprising an induction winding 3 according to the present invention and a laminated core. The core comprises three legs 30, 31, 32 and two yokes 33, 34. Induction windings according to the present invention are concentrically wound around the core's legs. Three such concentric induction windings 35, 36, 37 are shown. The inner induction winding 35 is a primary induction winding and the other two 36, 37 represent secondary induction windings.

Spacers 38 and 39 are placed between the induction windings. The spacers can either comprise electrically insulating material and function to facilitate cooling and to mechanically support the induction windings or they can comprise electrically conducting material and function as part of the grounding system for the induction windings.

FIG. 4 depicts schematically an axial end-view of a sector of the stator 40 of an electric machine according to the present invention. The figure shows a sector of the machine corresponding to one pole division. From a yoke portion 42 of the core situated radially outermost, a number of teeth 43 extend radially inwards towards the machines rotor 41. The teeth are separated by slots 44 in which the stator's induction winding is arranged. Only the current-carrying means 10 of the induction winding has been shown for clarity. Each slot 44 has varying cross-section with alternating wider parts 45 and narrower parts 46. The wider parts 45 are substantially circular and surround the induction winding lead-throughs. The narrower parts serve to radially position each induction winding lead-through. The cross-section of the slot 44 as a whole becomes slightly narrower in the direction radially inwards. This is because the voltage in the induction winding lead-throughs is lower the closer they are situated to the radially inner part of the stator. Narrower cable lead-throughs can therefore be used here, whereas increasingly wider cable lead-throughs are required further out. In the embodiment shown, induction windings of three different dimensions are used, arranged in three correspondingly dimensioned sections 47, 48, 49 of the slots 44.

By using an induction winding according to the present invention in the stator winding of a generator for example, the voltage of the generator can be increased to such a level that it can be connected directly to a power network without the need of an intermediate transformer. Consequently, the solution according to the present invention leads to savings in both economic terms and with regards to space requirements for installations comprising a rotating electric machine.

FIG. 5 shows eddy current losses at different alternating (50 Hz) magnetic fields where the magnetic field was at right angles to the current-carrying means. The graph compares calculated values for a solid copper conductor having a cross-sectional area of 185 mm² with experimental values obtained from measurements on thirty-six circular copper strands having the same total cross-sectional area as the solid conductor. The copper strands were arranged in three different configurations. In a first configuration they were left uninsulated and compressed. The data shows that using this configuration leads to a decrease in eddy current losses compared with the solid conductor. In a second configuration the strands were all insulated but not compressed which led to a further decrease in eddy current losses. In a third configuration they were left uninsulated but were layer-insulated and compressed according to an embodiment of the present invention which gave virtually the same result as the uncompressed insulated strands over the range of magnetic fields measured. This graph shows that eddy current losses within individual layers of compressed layer-insulated strands are negligible and therefore all electrical insulation within individual layers can be omitted without having a significantly adverse effect.

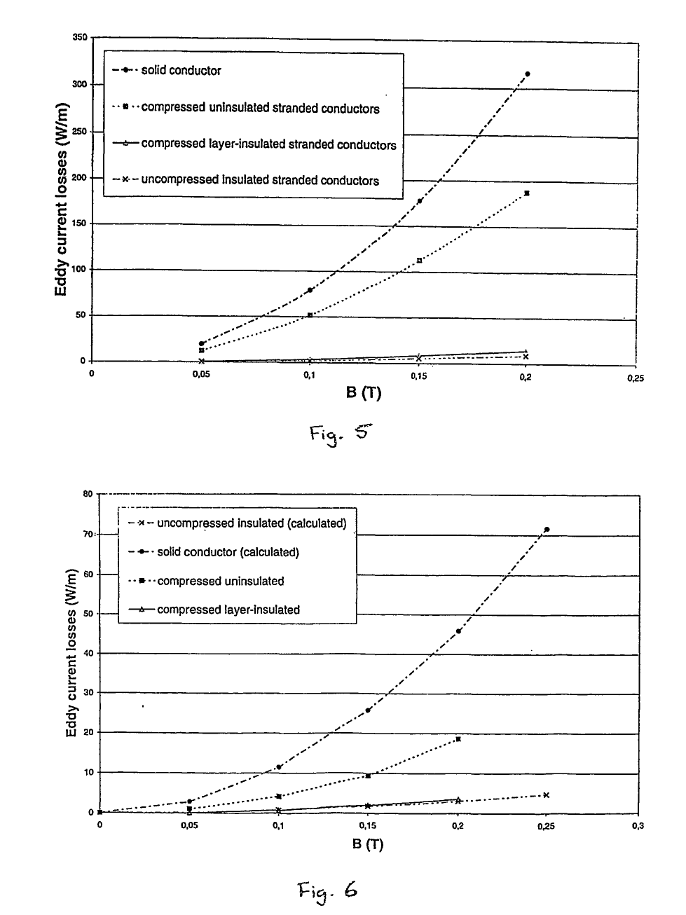

FIG. 6 shows eddy current losses at different alternating (50 Hz) magnetic fields where the magnetic field was at right angles to the current-carrying means. The graph compares calculated values for an induction winding solid comprising a solid copper conductor having a cross-sectional area of 70 mm² with experimental values obtained from measurements on induction windings containing circular copper strands having the same total cross-sectional area as the solid conductor. The copper strands were arranged in three different configurations. In a first configuration they were left uninsulated and compressed. The data shows that using this configuration leads to a decrease in eddy current losses compared with the solid conductor. In a second configuration the strands were all insulated but not compressed which led to a further decrease in eddy current losses. In a third configuration they were left uninsulated but were layer-insulated and compressed according to an embodiment of the present invention which gave virtually the same result as the configuration comprising uncompressed insulated strands over the range of magnetic fields measured.

While only certain features of the present invention have been illustrated and described, many modifications and changes will be apparent to those skilled in the art. It is therefore to be understood that all such modifications and changes of the present invention fall within the scope of the claims.

1. An induction winding (20) consisting of at least one turn, containing current-carrying means (10) comprising stranded conductors (11) arranged in at least one layer, characterized in that at least two adjacent strands constituting the said at least one layer are uninsulated.

2. An induction winding according to claim 1, characterized in that the induction winding comprises a plurality of perimetrically superimposed layers (12, 13, 14) where each layer is electrically insulated from adjacent layers (16, 17, 18),

3. An induction winding according to claim 2, characterized in that the said plurality of perimetrically superimposed layers are substantially concentric

4. An induction winding according to any of the previous claims, characterized in that the majority of strands constituting the said at least one layer are uninsulated.

5. An induction winding according to any of the previous claims, characterized in that all of the strands constituting the said at least one layer are uninsulated.

6. An induction winding according to any of the previous claims, characterized in that the strands have a pre-shaped cross section.

7. An induction winding according to any claims 1-4, characterized in that the strands are compressed after stranding.

8. An induction winding according to any of the previous claims, characterized in that the maximum transverse dimension of the strands is 4 mm, preferably 2 mm.

9. An induction winding according to any of the previous claims, characterized in that the electrical insulation between each layer of stranded conductors (16, 17, 18) comprises paper or a synthetic material.

10. An induction winding according to claim 8, characterized in that the said electrical insulation between each layer (16, 17, 18) is applied longitudinally onto the layers of stranded conductors (12, 13, 14).

11. An induction winding according to claim 8, characterized in that the said electrical insulation between each layer (16, 17, 18) is wound onto the layers of stranded conductors (12, 13, 14).

12. An electric machine comprising at least one induction winding (20) consisting of at least one turn, characterized in that the said winding (20) comprises current-carrying means (10) according to any of the previous claims, enclosed within a first semiconducting layer (21), which is provided with a surrounding solid insulation layer (22) and a second semiconducting layer (23) which encases the solid insulation layer

13. An electric machine according to claim 12, characterized in that it comprises means for maintaining the first semiconducting layer (21) at a potential substantially equal to the potential of the current-carrying means.

14. An electric machine according to claims 12 or 13, characterized in that the second semiconducting layer (23) is arranged to constitute a substantially equipotential surface surrounding the current-carrying means.

15. An electric machine according to any of claims 12-14, characterized in that the second semiconducting layer (23) is connected to a predetermined potential.

16. An electric machine according to claims 15, characterized in that the said predetermined potential is ground potential.

17. A method of providing current-carrying means for an induction winding, characterized in that it comprises the steps of arranging stranded conductors in at least one layer (12,13,14) so that at least two uninsulated strands (11) are arranged adjacently within a layer and electrically insulating each layer from adjacent layers.

18. A method of producing an induction winding, characterized in that it comprises the steps of enclosing the current-carrying means inside a first semiconducting layer (21), providing a surrounding solid insulation layer (22) around the first semiconducting layer and encasing the solid insulation layer with a second semiconducting layer (23).

19. A method according to claim 18, characterized in that the first semiconducting layer (21), the solid insulation layer (22) and the second semiconducting layer (23) are extruded together to form a single unit.

20. Use of an induction winding according to any of claims 1-11 or a method according to any of claims 17-19 in a static electric machine.

21. Use of an induction winding according to any of claims 1-11 or a method according to any of claims 17-19 in a rotating electric machine.

22. Use of an induction winding according to any of claims 1-11 or a method according to any of claims 17-19 in high voltage applications.

23. Use of an induction winding according to any of claims 1-11 or a method according to any of claims 17-19 in a transformer.

24. Use of an induction winding according to any of claims 1-11 or a method according to any of claims 17-19 in a reactor.

25. Use of an induction winding according to any of claims 1-11 or a method according to any of claims 17-19 in an electromagnet.

26. Use of an induction winding according to any of claims 1-11 or a method according to any of claims 17-19 in a compensator.

27. Use of an induction winding according to any of claims 1-11 or a method according to any of claims 17-19 in a frequency converter.

28. Use of an induction winding according to any of claims 1-11 or a method according to any of claims 17-19 in a motor.

29. Use of an induction winding according to any of claims 1-11 or a method according to any of claims 17-19 in a generator.
